(19) United States
(12) Patent Application Publication
(10) Pub. No.: US 2009/0011918 A1
(43) Pub. Date: Jan. 8, 2009

(54) Optical glass and optical element

(75) Inventors: Takashi Tsutsumi, Osaka (JP); Yasuki Takeshita, Osaka (JP)

Correspondence Address: BIRCH STEWART KOLASCH & BIRCH, PO BOX 747, FALLS CHURCH, VA, 22040-0747, US

(73) Assignee: OMG. CO., LTD.

(21) Appl. No.: 12/149,442

(22) Filed: May 1, 2008

(30) Foreign Application Priority Data
May 11, 2007 (JP) 2007-127158

(51) Int. Cl. C03C 3/068; C03C 3/04

(52) U.S. Cl. 501/78; 501/53

(57) ABSTRACT

An optical glass of the present invention has optical constants with a refractive index (nd) of 1.74 to 1.76 and an Abbe number (υd) of 45 to 49.5, contains SiO₂, B₂O₃, BaO, ZnO, La₂O₃, Gd₂O₃, TiO₂, Al₂O₃, and Li₂O as essential components, does not contain Ta₂O₅, GeO₂, or ZrO₂ which usually affects the stabilization of glass, does not contain lead, arsenic, or fluorine having adverse effects on the environment, and has a glass transition point Tg of 530 to 590° C.

According to the present invention, a stable glass for precision press-molding can be provided which has a low glass transition temperature (Tg), has a high refractive index and a low dispersion property, and does not contain expensive Ta₂O₅, GeO₂, ZrO₂, or Y₂O₃.

### BACKGROUND OF THE INVENTION

1. Field of the Invention

The present invention relates to an optical glass for precision pressing having a high refractive index and a low dispersion property, and more particularly to an optical glass of low costs, being excellent in glass stability such as chemical durability, heat resistance devitrification property, and press moldability.

2. Description of the Prior Art

In recent years, rise in the price of glass raw materials is conspicuous, and rare earth raw materials have a high tendency thereof. In particular, such as Ta₂O₃ and GeO₂ are extremely expensive raw materials.

On the other hand, regarding a glass of lanthanum borate system, a glass for precision press-molding having a high refractive index and a high Abbe number is strongly demanded. Here, as the optical glass for precision pressing having a high refractive index and a low dispersion property, the inventions described in Japanese Patent Laid-open Publications No. 2002-249337 and No. 2006-117506 are known, for example.

Japanese Patent Laid-open Publication No. 2002-249337 describes an invention of optical glass that is composed of 45 to 65 mol % of B₂O₃, 5 to 22 mol % of La₂O₃, 1 to 20 mol % of Gd₂O₃ (here, the total content of La₂O₃ and Gd₂O₃ is 14 to 30 mol %), 5 to 30 mol % of ZnO, 0 to 10 mol % of SiO₂, 0 to 6.5 mol % of ZrO₂, and 0 to 1 mol % of Sb₂O₃.

On the other hand, Japanese Patent Laid-open Publication No. 2006-117506 describes an invention of optical glass containing SiO₂, B₂O₃, La₂O₃, Gd₂O₃, ZrO₂, Ta₂O₅, ZnO, and Li₂O as essential components, where ZnO/(ZrO₂+Ta₂O₅) is 0.45 to 1.5.

However, each of the above-described inventions has a problem in that each of which contains ZrO₂ as an essential component. Namely, ZrO₂ not only raises production costs but also has a high melting point, so that when ZrO₂ is contained, it will be difficult to realize desired optical characteristics at a low cost. Here, for the optical lens described in Japanese Patent Laid-open Publication No. 2002-249337, there exists an Example in which the optical lens contains no ZrO₂. However, since each of these lenses does not contain SiO₂, the glass stability will be insufficient.

The present invention has been made in view of the aforementioned problems, and it is an object to provide an optical lens having desired optical constants without the use of expensive raw materials such as Ta₂O₅, GeO₂, ZrO₂, and Y₂O₃, as well as an optical element made of such optical glass.

### SUMMARY OF THE INVENTION

In order to achieve the aforementioned object, the present inventors have made various studies and, as a result, have realized desired optical characteristics and glass stability without letting Ta₂O₅, GeO₂, or the like be contained by introducing Al₂O₃ being less expensive and having a lower melting point than ZrO₂ as an essential component, thereby having realized a glass for precision pressing being excellent in glass stability at a low cost.

Namely, the present invention is an optical glass having optical constants with a refractive index (nd) of 1.74 to 1.76 and an Abbe number (υd) of 45 to 49.5, containing SiO₂, B₂O₃, BaO, ZnO, La₂O₃, Gd₂O₃, Al₂O₃, and Li₂O as essential components, and substantially not containing Ta₂O₅, GeO₂, or ZrO₂. Here, it is a matter of course that the optical glass of the present invention does not contain lead, arsenic, or fluorine having adverse effects on the environment.

In addition, the present invention is an optical element made of the above-described optical glass. As the optical element, an optical lens used in optical apparatus such as a digital camera is typical. Moreover, it is a typical example that the glass of the present invention is used in the press-molding method, where a heated glass preform material is press-molded in a mold having a surface shape finished at a high precision to form a desired glass shape such as a lens.

The optical glass of the present invention preferably has a glass transition point (Tg) of 590° C. or below, more preferably 570° C. or below. Moreover, the yield point (At) can be made to be 560° C. to 605° C.

Additionally, the present invention is an optical glass containing 1.0 to 5.0% by mass of SiO₂, 20.0 to 28.0% by mass of B₂O₃, 1.0 to 4.0% by mass of BaO, 20.0 to 26.0% by mass of ZnO, 20.0 to 32.0% by mass of La₂O₃, 9.0 to 17.0% by mass of Gd₂O₃, 1.0 to 3.0% by mass of Al₂O₃, 0.2 to 1.8% by mass of Li₂O, as well as 0 to 3.0% by mass of TiO₂, 0 to 3.0% by mass of Nb₂O₅, 0 to 0.3% by mass of K₂O or Na₂O, and 0 to 0.1% by mass of Sb₂O₃.

SiO₂ is an oxide forming a glass net, and is an essential component for the stability of glass. It is necessary that the optical glass contains 1.0% by weight or more of SiO₂. However, when the content exceeds 5.0% by weight, there is a disadvantage that it is difficult to attain the intended At and Tg. A further preferable range is 1.2 to 3.0% by weight.

B₂O₃ is also the same oxide forming a glass net as SiO₂, and is an essential component for melting rare earth elements, thereby contributing to the stability of glass. In order to obtain the intended refractive index and Abbe number, it is necessary that the optical glass contains 20.0% by weight or more of B₂O₃. When the content exceeds 28.0% by weight, the water resistance becomes to be aggravated. A further preferable range is 24.0 to 27.0% by weight.

ZnO is an essential component for lowering the glass transition point and the yield point, and for raising the chemical durability. In order to obtain the intended refractive index and Abbe number, it is necessary that the optical glass contains 20.0% by weight or more of ZnO. When the content exceeds 26.0% by weight, it will be difficult to obtain the intended refractive index and Abbe number. A further preferable range is 22.0 to 25.0% by weight.

BaO is an essential component for obtaining the intended Abbe number. In order to obtain the intended Abbe number, it is necessary that the optical glass contains 1.0% by weight or more of BaO. When the content exceeds 4% by weight, the intended refractive index cannot be obtained. A further preferable range is 2.5 to 3.5% by weight.

La₂O₃ is a high-refraction and low-dispersion component. In order to obtain the intended refractive index and Abbe number, it is necessary that the optical glass contains 20.0% by weight or more of La₂O₃. When the content exceeds 32% by weight, the devitrification tendency increases. A further preferable range is 22.0 to 31.0% by weight.

Gd₂O₃ is a high-refraction and low-dispersion component, has a lower melting point than La₂O₃, and is an essential component for obtaining the intended transition point and yield point. It is necessary that the optical glass contains 9.0 to 17.0% by weight of Gd₂O₃. A further preferable range is 9.5 to 15.5% by weight.

TiO₂ is a component for raising the refractive index. However, since TiO₂ has a high dispersion, the intended Abbe number cannot be obtain unless the optical glass contains 3% by weight or less of TiO₂. On the other hand, in order to stabilize the glass, it needs to add preferably 0.5% by weight or more, more preferably 1.2 to 2.7% by weight of TiO₂.

Al₂O₃ is an essential component for obtaining the intended glass transition point and yield point, and is a substitute raw material of expensive raw materials (Ta₂O₅, GeO₂, and ZrO₂). It contributes to the stability of glass production. For that purpose, it is necessary that the optical glass contains 1.0% by weight or more of Al₂O₃. However, when the content exceeds 3.0% by weight, it will be difficult to melt the glass, and also there arise a problem of crystallization. A further preferable range is 1.8 to 2.5% by weight.

Li₂O is an essential component for obtaining the intended glass transition point and yield point. Unless the optical glass contains 0.05% by weight or more of Li₂O, the effect thereof will not appear. However, when the content exceeds 1.8% by weight, the crystallization will be large, thereby interrupting the production. Preferably, the optical glass should contain 0.2% by weight or more of Li₂O. A further preferable range is 0.3 to 1.6% by weight.

Na₂O and K₂O are not essential components. However, they may be contained at the same % by weight as a substitute for Li₂O. Each of them is exchangeable at an equivalent content. In the case of adding, the sum of these components can be set to 1.5% by weight or less. Preferably, the added amount of Na₂O and K₂O should be 0.3% by weight or less.

Nb₂O₅ is a component for raising the refractive index. However, when the content exceeds 3.0% by weight, the intended Abbe number cannot be obtained. Sb₂O₃ has an effect in foam elimination, though it is not an essential component. However, when the content exceeds 0.1% by weight, the crystallization will be liable to occur.

According to the present invention described above, an optical lens having desired optical constants can be realized without the use of expensive raw materials.

### BRIEF DESCRIPTION OF THE DRAWING

FIG. 1 is a view showing the composition and the optical characteristics of the Examples.

### DETAILED DESCRIPTION OF THE INVENTION

Hereafter, Examples of the present invention will be described. The present invention is not limited to these Examples.

The optical glass of the Examples 1 to 9 of the present invention was obtained by weighing and mixing ordinary optical glass raw materials such as oxide, carbonate, hydroxide, and nitrate so as to attain a composition ratio of the Examples, putting the mixture into a platinum crucible, melting the mixture at 1300 to 1400° C. for one to two hours, stirring and leaving the mixture to stand quietly for homogenization, and casting the mixture into a mold. The cast glass was gradually cooled at a speed of −2.3° C./1.0 hour to produce a sample.

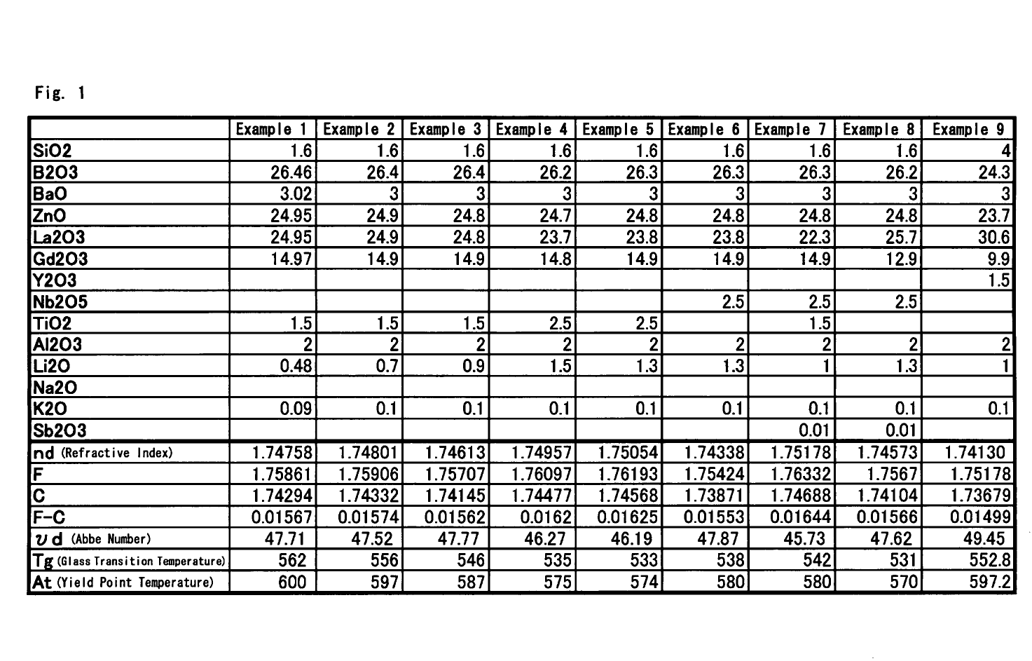

The composition and the optical characteristics of each Example are as shown in FIG. 1. Here, the refractive index measurement (nd) and the Abbe number were obtained by using a sample that had been cooled at a speed of −2.3° C./1.0 hour. For the measurement, the Abbe number was calculated by using KPR30 manufactured by Kalnew Co., Ltd.

In addition, the glass transition temperature and the yield point temperature were measured by use of TMA measurement apparatus manufactured by Rigaku Corporation with processing the above-described measurement sample into a 5 mm square having a length of 30 mm.

1. An optical glass having optical constants with a refractive index (nd) of 1.74 to 1.76 and an Abbe number (υd) of 45 to 49.5, containing SiO₂, B₂O₃, BaO, ZnO, La₂O₃, Gd₂O₃, Al₂O₃, and Li₂O as essential components, and substantially not containing Ta₂O₅, GeO₂, or ZrO₂.

2. The optical glass according to claim 1, having a glass transition point (Tg) of 590° C. or below.

3. An optical glass containing:
1.0 to 5.0% by mass of SiO₂,
20.0 to 28.0% by mass of B₂O₃,
1.0 to 4.0% by mass of BaO,
20.0 to 26.0% by mass of ZnO,
20.0 to 32.0% by mass of La₂O₃,
9.0 to 17.0% by mass of Gd₂O₃,
1.0 to 3.0% by mass of Al₂O₃, and
0.2 to 1.8% by mass of Li₂O,
as well as
0 to 3.0% by mass of TiO₂,
0 to 3.0% by mass of Nb₂O₅,
0 to 0.3% by mass of K₂O or Na₂O, and
0 to 0.1% by mass of Sb₂O₃ as components.

4. An optical element comprising the optical glass according to claim 1.

5. An optical element comprising the optical glass according to claim 2.

6. An optical element comprising the optical glass according to claim 3.
